(19) United States
(12) Patent Application Publication
(10) Pub. No.: US 2003/0168647 A1
(43) Pub. Date: Sep. 11, 2003

(54) Cable controlled crane, methods for making and using same

(76) Inventors: Clark James Thompson, Rosharon, TX (US); Ronald Gustav Presswood, Houston, TX (US)

Correspondence Address: ROBERT W STROZIER, P.L.L.C, PO BOX 429, BELLAIRE, TX, 77402-0429, US

(21) Appl. No.: 10/357,295

(22) Filed: Feb. 3, 2003

Related U.S. Application Data
(60) Provisional application No. 60/356,062, filed on Feb. 11, 2002.

(51) Int. Cl. B66D 1/48

(52) U.S. Cl. 254/270

(57) ABSTRACT

A platform apparatus is disclosed including an end effector, a plurality of tension members, a plurality of controllers and a digital processing unit in command communication with the controllers, where each tension member is connected at its distal end to a vertex of the end effector and at its proximal end to one of the controllers, where the controllers control a length of each tension member, thereby controlling the position of the end effector within a volume defined by locations of the controllers and where the digital processing unit controls the controllers. The apparatus can also include a plurality of support members which support the tension members and/or the controllers, one or more controllers allocated to each support member. Methods are also described for the installation and used of the platform apparatus of this invention.

RELATED APPLICATIONS

This application claims provisional priority to U.S. Provisional Patent Application Serial No. 60/356,062, filed Feb. 11, 2002.

### BACKGROUND OF THE INVENTION

1. Field of the Invention

The present invention relates to a platform apparatus including an end effector and a plurality of cables controlling the end effector and to methods for making, installing and using the apparatus.

More particularly, the present invention relates to a platform apparatus including an end effector, a plurality of cables, a plurality of cable control devices and a digital processing unit adapted to control the cable control devices, where the cables are connected at their distal ends to the end effector in a space apart configuration and each cable is connected at its proximal end to one of the cable control devices and where the end effector position is controlled by the length on the cables. The prevent invention also relates to methods for making, installing and using the crane.

2. Description of the Related Art

In many industries, the ability to lift and move objects, materials, equipment or the like is of critical importance. Generally, the apparatus that lift and move objects are crane type apparatus that include single arm cranes, operated by cables and winches, tower type cranes, and bridge cranes, to name a few prior crane devices. Each of these types of cranes are large and require large support structures to operate.

In other industries, the ability to apply material such as paint, cleaning material or the like to a stationary surface, flat or curved, is of importance or the ability to remove material from a stationary surface, flat or curved, is of importance. Such application equipment is generally either man power intensive or relatively bulky and hard to use.

In yet other industries, the ability to move a platform in such a way as to simulate movement in up to six degrees of freedom, up-down, side-to-side, back-and-forth, twist in x, twist in y, twist in z, or combinations of such motions, are of critical importance. Currently, systems that provide such motion are large and involve hydraulic lifts.

Thus, there is a need in the art for a more versatile platform apparatus that does not require a large support structure and can be installed and operated anywhere including in open areas, in preexisting structures, or structure under construction and can lift and move objects, apply material to surfaces or simulate motion.

### SUMMARY OF THE INVENTION

General Platform Apparatus of This Invention

The present invention provides a platform apparatus including an end effector and a plurality of cables controlling the end effector.

The present invention also provides a platform apparatus including an end effector having a plurality of cable connectors, a plurality of cable control apparatuses, a plurality of cables, each cable connected at its proximal ends to one of the cable control apparatuses and at its distal end to one of the connectors on the end effector in a spaced apart configuration, and a digital processing unit in control communication with each cable control apparatus, where the digital processing unit simultaneously controls the cable control apparatus, the cable control apparatuses control a tension on and a length of the cables, and the length of the cables control a position of the end effector.

The present invention also provides a platform apparatus including an end effector, a plurality of cables controlling the end effector, a plurality of cable control apparatuses controlling a length of and tension on the cables, a plurality of towers and a digital processing unit adapted to control the cable control apparatuses, where each cable connects at its distal end to the end effector, passes over one of the towers and connects at its proximal end to one of the cable control apparatuses associated with that tower and where the cable are connected to the end effector in a spaced apart configuration, where the digital processing unit simultaneously controls the cable control apparatus, the cable control apparatuses control a tension on and a length of the cables, and the length of the cables control a position of the end effector and the towers are distributed at corners of a polygon.

The present invention also provides a platform apparatus including an end effector, a plurality of cables controlling the end effector, a plurality of cable control apparatus housings, each housing including a cable control apparatus and a digital processing unit adapted to control the cable control apparatuses, where the cables connect at their distal ends to the end effector in a spaced apart configuration and connect at their proximal ends to one of the cable control apparatuses, the digital processing unit simultaneously controls the cable control apparatuses, the cable control apparatuses control a tension on and a length of the cables, the length of the cables control a position of the end effector and the housings are located at corners of a polygon.

The present invention also provides a platform apparatus including an end effector, a plurality of cables controlling the end effector, a plurality of towers, each including at least one cable control apparatus and a digital processing unit adapted to control the cable control apparatuses, where each cable connects at its distal end to the end effector, passes over one of the towers and connects at its proximal end to one of the cable control apparatuses associated with that cable, the cables are connected to the end effector in a spaced apart configuration, the digital processing unit simultaneously controls the cable control apparatuses, the cable control apparatuses control a tension on and a length of the cables, the length of the cables control a position of the end effector, the towers are distributed at corners of a polygon and the apparatus is capable of attaching to, moving and detaching from objects such as palettes, containers or the like.

The present invention also provides a platform apparatus including an end effector, a plurality of cables controlling the end effector, a plurality of cable control apparatus housings, each housing including at least one cable control apparatuses and a digital processing unit adapted to control the cable control apparatus, where each cable connects at its distal end to the end effector and connects at its proximal end to one of the cable control apparatus, the cables are connected to the end effector in a spaced apart configuration, the digital processing unit simultaneously controls the cable control apparatuses, the cable control apparatuses control a tension on and a length of the cables, the length of the cables control a position of the end effector and the housings are located at the corners of a polygon.

Method for Using the Platform Apparatus of This Invention

The present invention also provides a method for lifting an object including the steps of positioning an end effector of a platform apparatus of this invention above the object, attaching an object attachment member of the end effector to an end effector attachment member of the object, and lifting the object, where all movements of the end effector results from simultaneously changing the lengths of some or all of the cables.

The present invention also provides a method for moving an object including the steps of positioning an end effector of a platform apparatus of this invention above the object, attaching an object attachment member of the end effector to an end effector attachment member of the object, lifting the object, moving the end effector with the attached object to a new position, lowering the end effector with the object attached until the object is supported on a support surface, and detaching the object attachment member from the end effector attachment member, where all movements of the end effector result from simultaneously changing the lengths of some or all of the cables.

The present invention also provides a method for loading a container including the steps of: positioning an end effector of a platform apparatus of this invention above the object, attaching an object attachment member of the end effector to an end effector attachment member of the object, lifting the object, moving the end effector with the attached object to a desired position inside the container, lowering the end effector and/or the object attached thereto until the object is supported on a support surface at the desired position inside the container, and detaching the object attachment member from the end effector attachment member, where all movements of the end effector results from simultaneously changing the lengths of some or all of the cables. The method can also include repeating the above steps until the container is filled to a desired capacity, which is less than or equal to a maximum capacity of the container. The method can also include the steps of closing and locking the container.

The present invention also provides a method of removing a material from a surface including the steps of equipping the surface with a platform apparatus of this invention, positioning the end effector, having a material removal apparatus associated with its lower surface, above the surface at a material removal start point and moving the end effector along a predetermined path, while removing a layer of the material from the surface along the predetermined path.

The present invention also provides a method for applying a material to a surface including the steps of equipping the surface with a platform apparatus of this invention, positioning the end effector, having a material applicator associated with its lower surface, above the surface at a material application start point and moving the end effector along a predetermined path, while applying a layer of the material to the surface along the predetermined path.

The present invention also provides a method for cleaning a surface including the steps of equipping the surface with a platform apparatus of this invention, positioning the end effector, having a cleaning apparatus associated with its lower surface, above the surface at a start point and moving the end effector along a predetermined path, while cleaning the surface along the predetermined path.

The present invention also provides a method for simulating motion including the steps of simultaneously changing the length of one to all of the cables connected to the end effector according to a predefined motion simulation, which can be ordered or random.

Method for Installing the Platform Apparatus of This Invention

The present invention also relates to a method of installing a platform apparatus of this invention inside a pre-existing structure including the steps of securing a plurality of cable control apparatuses, each apparatus having at least one pivoting cable guide; attaching one end of at least one cable to each cable control apparatus; threading a second end of each cable through the cable guides; attaching the second end of each cable to a specific cable connector on an end effector having a plurality of cable connectors; and placing each cable control apparatus in control communication with a digital processing unit, the digital processing unit simultaneously controls the cable control apparatuses, the cable control apparatuses control a tension on and a length of the cables, and the lengths of the cables control a position of the end effector.

Cranes or Lifting Apparatus

The present invention provides a crane including an end effector including an attachment member on its lower surface and a plurality of cables controlling the end effector, where the cables and end effector are sized to lift an object of a given maximum weight and/or size.

The present invention also provides a crane including an end effector, a plurality of cables controlling the end effector, a plurality of cable control apparatuses and a digital processing unit adapted to control the cable control apparatus, where the cables are connected at their distal ends to the end effector in a configuration adapted to allow the cable control apparatus to control a position of the end effector and where each cable is connected at its proximal end to one of the cable control apparatus.

The present invention also provides a crane including an end effector, a plurality of cables controlling the end effector, a plurality of cable control apparatuses, a plurality of towers and a digital processing unit adapted to control the cable control apparatus, where each cable connects at its distal end to the end effector, passes over one of the towers and connects at its proximal end to one of the cable control apparatus and where the cable are connected to the end effector in a configuration adapted to allow the cables to control a position of the end effector via the cable control apparatuses and where the towers are distributed at corners of a polygon.

The present invention also provides a crane including an end effector, a plurality of cables controlling the end effector, a plurality of cable control apparatus housings including a cable control apparatus and a digital processing unit adapted to control the cable control apparatus, where each cable connects at its distal end to the end effector and connects at its proximal end to one of the cable control apparatus and where the cable are connected to the end effector in a configuration adapted to allow the cables to control a position of the end effector via the cable control apparatuses and where the housings are located at corners of a polygonal shaped structure.

The present invention also provides a crane including an end effector, a plurality of cables controlling the end effector, a plurality of cable control apparatuses, a plurality of towers and a digital processing unit adapted to control the cable control apparatus, where each cable connects at its distal end to the end effector, passes over one of the towers and connects at its proximal end to one of the cable control apparatus and where the cable are connected to the end effector in a configuration adapted to allow the cables to control a position of the end effector via the cable control apparatuses and where the towers are distributed at corners of a polygon.

The present invention also provides a crane including an end effector, a plurality of cables controlling the end effector, a plurality of cable control apparatus housings including a cable control apparatus and a digital processing unit adapted to control the cable control apparatus, where each cable connects at its distal end to the end effector and connects at its proximal end to one of the cable control apparatus and where the cables are connected to the end effector in a configuration adapted to allow the cables to control a position of the end effector via the cable control apparatuses and where the housings are located at the corners of a polygonal shaped structure.

Structure Including Cranes of This Invention

The present invention also provides a temporary structure including a covering and a crane having an end effector, a plurality of cables controlling the end effector, a plurality of cable control apparatuses, a plurality of towers and a digital processing unit adapted to control the cable control apparatus, where each cable connects at its distal end to the end effector, passes over one of the towers and connects at its proximal end to one of the cable control apparatus and where the cable are connected to the end effector in a configuration adapted to allow the cables to control a position of the end effector via the cable control apparatuses and where the towers are distributed at corners of a polygonal shape and where the covering extends from a base of each tower and forms an temporary protected interior space between the towers.

The present invention also provides a structure including a crane having an end effector, a plurality of cables controlling the end effector, a plurality of cable control apparatuses, a plurality of towers and a digital processing unit adapted to control the cable control apparatus, where each cable connects at its distal end to the end effector, passes over one of the towers and connects at its proximal end to one of the cable control apparatus and where the cable are connected to the end effector in a configuration adapted to allow the cables to control a position of the end effector via the cable control apparatuses and where the towers are distributed at corners of a polygonal shape situated in an interior of the structure.

The present invention also provides a structure including a crane including an end effector, a plurality of cables controlling the end effector, a plurality of cable control apparatus housings including a cable control apparatus and a digital processing unit adapted to control the cable control apparatus, where each cable connects at its distal end to the end effector and connects at its proximal end to one of the cable control apparatus and where the cable are connected to the end effector in a configuration adapted to allow the cables to control a position of the end effector via the cable control apparatuses and where the housings are built into the structure to form a polygonal shape, where the housings are preferentially located in walls at or near the corners of the structure.

The present invention also provides a portable crane including an end effector, a plurality of cables controlling the end effector, a plurality of towers, a plurality of cable control apparatuses and a digital processing unit adapted to control the cable control apparatus, where each cable connects at its distal end to the end effector and connects at its proximal end to one of the cable control apparatus and where the cable are connected to the end effector in a configuration adapted to allow the cables to control a position of the end effector via the cable control apparatuses and where the towers are distributed at the corners of a polygonal shaped area.

The present invention also provides a garage crane including an end effector, a plurality of cables controlling the end effector, a plurality of cable control apparatus housings including a cable control apparatus or a plurality of towers and cable control apparatus and a digital processing unit adapted to control the cable control apparatus, where each cable connects at its distal end to the end effector and connects at its proximal end to one of the cable control apparatus and where the cable are connected to the end effector in a configuration adapted to allow the cables to control a position of the end effector via the cable control apparatuses and where the housings are built into supports substructures at the corners of the garage or the cable control apparatus are associated with the towers which are positioned at the corners of the garage.

Method for Using the Cranes of This Invention

The present invention also provides a method for lifting an object including the steps of positioning an end effector of a crane of this invention above the object, attaching an object attachment member of the end effector to an end effector attachment member of the object, and lifting the object.

The present invention also provides a method for moving an object including the steps of positioning an end effector of a crane of this invention above the object, attaching an object attachment member of the end effector to an end effector attachment member of the object, lifting the object, moving the end effector with the attached object to a new position, lowering the end effector with the object attached until the object is supported on a support surface, and detaching the object attachment member from the end effector attachment member.

The present invention also provides a method for managing inventory in a warehouse including the steps of: creating an inventory of columns of containers in the warehouse, where the inventory includes a column specifier, a column position specifier, contents specifier, and optionally an activity history; selecting a container; positioning an end effector of a crane of this invention over a column including the selected container, attaching a container attachment member to a top container of the selected column; activating the container attachment member to lock all containers above the selected container; lifting the attached containers; moving the containers to a temporary or new column; lowering the attached containers until a bottom container contacts either a warehouse floor or a container; deactivating the container attachment member to unlock the locked containers; detaching the container attachment member; repositioning the end effector above the selected container; attaching the container attachment member to the selected container; and lifting the selected container.

The present invention also provides a method for top loading a container transport vessel including the steps of: positioning an end effector of a crane of this invention above at least one container to be placed in the vessel; attaching an container attachment member to an end effector attachment member of the at least one container; moving the at least one container to a position above a site in the vessel; placing the at least one container in the vessel at the site; and detaching the container attachment member. The method can also include repeating the above step until the vessel is filled to a desired capacity, which is less than or equal to a maximum capacity of the vessel. The method can also include the step of placing a vessel top on the vessel and locking the top to seal the vessel.

The present invention also provides a method for top loading a container transport vessel including the steps of: positioning an end effector of a crane of this invention above a stack to containers to be placed in the vessel, where the stack height is less than or equal to a maximum height of the vessel; attaching a container attachment member to an end effector attachment member of the container at the top of the stack; optionally locking the each container in the stack to its neighbor; moving the stack to a position above a site in the vessel; placing the stack in the vessel at the site; and detaching the container attachment member. The method can also include repeating the above step until the vessel is filled to a desired capacity, which is less than or equal to a maximum capacity of the vessel. The method can also include the step of placing a vessel top on the vessel and locking the top to seal the vessel.

The present invention also provides a method for simulating the motion o fan aircraft including an airplane or a space craft, where the method comprising the steps of connecting a distal end of a plurality of cables to different vertices of a simulator and the proximal end of each cable to one of a plurality of cable controllers, sending commands from a control unit in command communication with the cable controllers to the controllers to affect changes in a length of the some or all of the cables according to a predefined set of change commands, to a series of random change commands or a mixture or predefined and random change commands, where controllers are either located at a given height above the ground or the cables are threaded through guides on the top of a tower or support member, where the support member a positioned at the vertices of a polygon with the simulator located within an interior of a polygon, where the lengths of the cables control an xyz position and a pitch, yaw and roll of the simulator. The simulator can also include a plurality of stabilization cables connected to a set of stabilization cable controller resting or attached to a floor at the vertices of the polygon so that the cables extend from the floor upward to lower vertices of the simulator to impart stability to the simulator and where the stabilization controllers are also in command communication with the control unit.

The present invention also provides a method for applying a material to a top surface (ceiling) of a structure comprising the steps of hanging a platform apparatus of this invention from corners of the surface and controlling a length of each the cables to permit the end effector with a material applicator located on its top surface to apply the material to the surface. If the surface is a curved surface, the preferred number of towers and controllers is three, while the number of cables can range from 3 to 6 or more depending on the geometrical nature of the end effector.

The present invention also provides a method for removing a material from a top surface (ceiling) of a structure comprising the steps of hanging a platform apparatus of this invention from corners of the surface and controlling a length of each the cables to permit the end effector with a material remover located on its top surface to remove the material to the surface. If the surface is a curved surface, the preferred number of towers and controllers is three, while the number of cables can range from 3 to 6 or more depending on the geometrical nature of the end effector.

Method for Installing Cranes of This Invention in a Structure

The present invention also relates to a method of installing a crane of this invention in a pre-existing structure including the steps of: anchoring a plurality of tower members to a floor of the structure so that the towers are secured to the floor and capable of bearing a pre-determined load, where the tower members are situated at the corners or vertices of a polygon having a number of sides corresponding to the plurality of towers; attaching a cable control apparatus at a base of each tower on face of the tower outside the polygon; attaching a first end of a cable to each cable control apparatus; threading each cable through cable guides attached to a top of each tower; attaching a second end of each cable to a cable connector on an end effector; and placing each cable control apparatus in control communication with a digital processing unit.

The present invention also relates to a method of installing a crane of this invention in a pre-existing structure including the steps of: anchoring a plurality of housings at or near a corner of the structure at a sufficient height above a floor of the structure to allow for effective crane operations; placing a cable control apparatus in each housing; attaching a first end of a cable to each cable control apparatus; threading each cable through cable guides attached to the housing, where the cable guide pivots about an axis to decrease twisting on the cable; attaching a second end of each cable to a cable connector on an end effector; and placing each cable control apparatus in control communication with a digital processing unit.

### DESCRIPTION OF THE DRAWINGS

The invention can be better understood with reference to the following detailed description together with the appended illustrative drawings in which like elements are numbered the same:

FIG. 1A depicts a top view of a motion platform of this invention including towers located in corners of a quadrilateral, controller located at the base of the towers and four cables attached to the top four vertices of the end effector in a non-crossing format;

FIG. 1B depicts a perspective view of the platform of FIG. 1A;

FIG. 2A depicts a top view of a motion platform of this invention including towers located in corners of a quadrilateral, controller located at the base of the towers and four cables attached to the top four vertices of the end effector in a crossing format;

FIG. 2B depicts a perspective view of the platform of FIG. 2A;

FIG. 3A depicts a top view of a motion platform of this invention including towers located in corners of a quadrilateral, controller located at the base of the towers and eight cables attached to the eight vertices of the end effector in a non-crossing format;

FIG. 3B depicts a perspective view of the platform of FIG. 3A;

FIG. 4A depicts a top view of a motion platform of this invention including towers located in corners of a quadrilateral, controller located at the base of the towers and eight cables attached to the eight vertices of the end effector, where the cables attached to the top vertices are in a cross-format and the cables attached to the bottom vertices are in a non-crossing format;

FIG. 4B depicts a perspective view of the platform of FIG. 4A;

FIG. 5A depicts a top view of a motion platform of this including towers located in corners of a quadrilateral, controller located at the base of the towers and eight cables attached to the eight vertices of the end effector, where the cables attached to the top vertices are in a first cross-format and the cables attached to the bottom vertices are in a second crossing format;

FIG. 5B depicts a perspective view of the platform of FIG. 5A;

FIG. 6A depicts a top view of a motion platform of FIG. 4A including four stabilization cables and four stabilization cable controllers located at an inner base of the towers;

FIG. 6B depicts a perspective view of the platform of FIG. 6A;

FIG. 7 depicts a top view of a motion platform of this invention including towers located in corners of a triangular solid, controller located at the base of the towers and six cables attached to the six vertices of the end effector;

FIG. 8 depicts a top view of a motion platform of this invention including towers located in corners of a pentagonal solid, controller located at the base of the towers and ten cables attached to the vertices of the end effector;

FIG. 9A depicts a top view of a platform apparatus of this invention, installed in a preexisting building, where the towers are located at the corners of the building and the towers are on rotatable foundations;

FIG. 9B depicts a perspective view of the platform apparatus of FIG. 9A;

FIG. 10A depicts a top view of a platform apparatus of this invention, installed in a preexisting building, where the housing are located in walls near the corners of the building and the winches are on rotatable foundations within the housing;

FIG. 10B depicts a perspective view of the platform apparatus of FIG. 10A;

FIGS. 11A-C depicts three views of a platform apparatus of this invention, where the end effector has been moved to three different position within its volume of access;

FIGS. 12A-C depicts three views of a platform apparatus of this invention being used to pick up and move an object from one position in its volume of access to another position within the volume;

FIGS. 13A-C depicts three views of a platform apparatus of this invention being used for inventory control, where a plurality of a given type of objects are assembled into a single stack having been distributed randomly along a plurality of stacks;

FIGS. 14A-C depicts three views of a platform apparatus of this invention being used to load or unload at top loading container;

FIGS. 15A-C depicts three views of a platform apparatus of this invention being used for apply a material to an exterior surface of a building; and

FIGS. 16A-C depicts three views of a platform apparatus of this invention being used for apply a material to a surface.

### DETAILED DESCRIPTION OF THE INVENTION

The inventors have found that a platform apparatus such as a crane, motion platform, applicators or the like can be quickly and easily constructed, installed and operated under manual or computer control in open spaces, pre-existing structures or structures being built. The platform apparatus can also be installed in vessels or other floating or semi-floating structures such as offshore rigs or the like. The inventors have found that by attaching winch controlled cables to a platform, referred to herein as an end effector, a platform position within a given volume can be controlled by varying the length and tension on each cable.

The inventors have also found that by varying the number of cables attached to the end effector and the configuration of the attached cable, not only can the position of the end effector be varied, but so can the pitch, yaw and roll of the end effector can be varied as well. The inventors have also found that by using computer controls and position/content databases, the platforms can be used for automated inventory control and automated loading and unloading warehousing of commodities, goods, equipment and the like. The inventors have also found that the platform apparatus of this invention can be constructed to lift and move very heavy equipment without the need of traditional crane assemblies, which generally include large support structures, while the present apparatus distributes the load over a number of load bearing structure, reducing the load that each member needs to bear.

The present invention relates broadly to a platform including a plurality of control apparatuses, a plurality of tension members, an end effector, and a digital processing unit in control communication with the control apparatuses, where one end of each tension member is attached to the end effector in a spaced apart configuration, the other end of each tension member is attached to one of the control apparatuses, the DPU controls the control apparatuses, the control apparatuses control a length and tension on each member, and the lengths of and tensions on the members control a position and an orientation of the end effector within a volume defined by relative locations of the control apparatuses.

The present invention relates broadly to a platform including a plurality of control apparatuses, a plurality of tension members, an end effector, and a digital processing unit in control communication with the control apparatuses, where one end of each tension member is attached to the end effector in a spaced apart configuration, the other end of each tension member is attached to one of the control apparatuses, the DPU controls the control apparatuses, the control apparatuses control a length and tension on each member, and the lengths of and tensions on the members control a position and an orientation of the end effector within a volume defined by relative locations of the control apparatuses.

The present invention also relates broadly to a platform including a plurality of control apparatuses, a plurality of tension members, an end effector, and a digital processing unit in control communication with the control apparatuses, where one end of each tension member is attached to the end effector in a spaced apart configuration, the other end of each tension member is attached to one of the control apparatuses, the DPU controls the control apparatuses, the control apparatuses control a length and tension on each member, and the lengths of and tensions on the members control a position, an orientation of the end effector within a volume defined by relative locations of the control apparatuses and the platform is capable of lifting objects having a weight between about 1 lb and about 100,000 lbs or more.

The present invention also relates broadly to a platform including a plurality of control apparatuses, a plurality of tension members, an end effector, and a digital processing unit in control communication with the control apparatuses, where one end of each tension member is attached to the end effector in a spaced apart configuration, the other end of each tension member is attached to one of the control apparatuses, the DPU controls the control apparatuses, the control apparatuses control a length and tension on each member, and the lengths of and tensions on the members control a position, an orientation of the end effector within a volume defined by relative locations of the control apparatuses, the platform is capable of lifting objects having a weight between about 1 lb and about 100,000 lbs or more and the platform is capable of simulating motion.

The present invention also relates broadly to a method for lifting a moving object comprising the steps of bringing the end effector of a platform of this invention into an engagement position with an object to be moved, detachably engaging the object; moving the object to a desired location and detaching the object—synchronizing motion with a moving vessel for unloading and loading while the vessel is motion—trains, ship, trucks, conveyor belts, or moving system.

The present invention also relates broadly to a method for top loading a container comprising the steps of bringing the end effector of a platform of this invention into an engagement position with an object to be loaded; detachably engaging the object; moving the object to a desired location within the container; detaching the object and repeating the bringing, engaging, moving and detaching steps until the container is loaded to a desired capacity.

The present invention also relates broadly to a method for warehousing objects comprising the steps of establishing an inventory of objects within a volume acceptable by a platform of this invention; bringing the end effector into an engagement position with an object of the inventory; detachably engaging the object; moving the object to a desired location; detaching the object and updating the inventory, where the inventory includes a location of each object in the volume, a description of each object and a date history of each object, where the date history includes an entry date into the inventory; any subsequent relocations of the object within the volume and a modification of the description of the object if needed.

In applications that involve moving objects from one place to another, the platform apparatuses of this invention can be used not only with stationary objects, but also with objects in motions. Thus, the platform apparatuses of this invention can be used to lift containers off of trains, truck, ships, conveyor systems or any other system that carries containers and is capable of motion. The platform apparatuses of this invention are controlled by computers that can be programmed to track moving objects, plot end effector trajectories to intercept, attach to and lift containers from the moving system. In reverse, the platform apparatuses of this invention, again, controlled by computers, can be programmed to track moving surfaces (truck beds, ship beds, surface of conveyor belts, train car beds, etc.), plot end effector trajectories to intercept the surface at a particular point, place a container on the moving surface. Such systems can greatly improve throughput and decrease loading and unloading times. Such systems would be ideally suited for containerized transportation system such as trains, truck, barges and/or ships.

The present invention also relates broadly to a method for simulating motion comprising the steps of positioning a user within an end effector of a platform of this invention; subjecting the end effector to a sequence of motions corresponding to commands issued by the user and to commands issued by a control system.

The cable control apparatuses can be any device designed to change the length of a cable by taking up cable or letting out cable depending what xyz position one desired to situate the end effector. Preferably, the control apparatus motor driven winches with computer control interfaces for remote control. For winches that control more than one cable simultaneous, the winches are preferably capable of controlling each cable separately having a separate reel for each cable and independent drive trains for each real. Such multiple reeled winches allow for simultaneous control and identical or non-identical control over the length of each cable.

Remote control can be accomplished by any control system. Preferably, remote control occurs using a digital processing unit with a user interface for interaction with a user. The digital processing unit can be any device and any software running thereon for controlling the cable control devices remotely. Any digital processing unit will do provided it has sufficient storage, computational power and speed to accomplish the simultaneous control of the cable controllers to allow the end effector to be moved from one position to another in a relatively smooth fashion. By relatively smooth fashion, one means that the end effector does not make sudden, erratic changes in length. Of course, in motion simulation application quick sudden a erratic changes may be just the ticket, so that the digital processing unit and the cable controller must be able to handle both a smooth procession from one point to another or an erratic change in xyz position of the end effector. Although, digital processing units are preferred, analog processing units can of course be used provided they meet the same criteria set forth above.

The software needed to control the winches can be any control software that is capable of rendering commands to a set of devices. The software must also be able to calculate changes in lengths of cables to accomplish a move of the end effector in its defined volume of utility. Some suitable systems are set forth in U.S. Pat. Nos. 4,710,819, 4,869,341, 5,408,407 and 5,440,476, incorporate herein by reference.

Suitable digital processing units or computer systems for use in this invention, include, without limitation, any device including a central processing unit for executing digital microcode and programs and an optional cache memory, a memory associated with the processing unit connected by a bus, optionally one or more mass storage devices such as a disk drive, solid state disks, CD drive or the like, connected to the processing unit and/or memory by a bus, communication hardware and software for communicating with external devices such as displays, printers, scanners, voiced activated devices, or the like as is well-known in the art. Such devices can be mainframe computer, mini-mainframe computer, PCs, palm, smart controllers, or the like. The computer equipment can be made by any manufacturer such as Compaq, Dell, Intel, Motorola, Apple, or the like. The computer equipment can also have loaded therein software including operating systems especially windowing operating systems, user interfaces especially graphics user interfaces, communication software, security software, internet browser software, or the like. 100821 Suitable operating systems running on the digital processing units of this invention, include, without limitation, windowing operating systems such as Window®, Linux®, Apple® OS, or the like, or any other operating system capable of supporting the programs operating the cable control devices and other software used in the apparatuses of this invention.

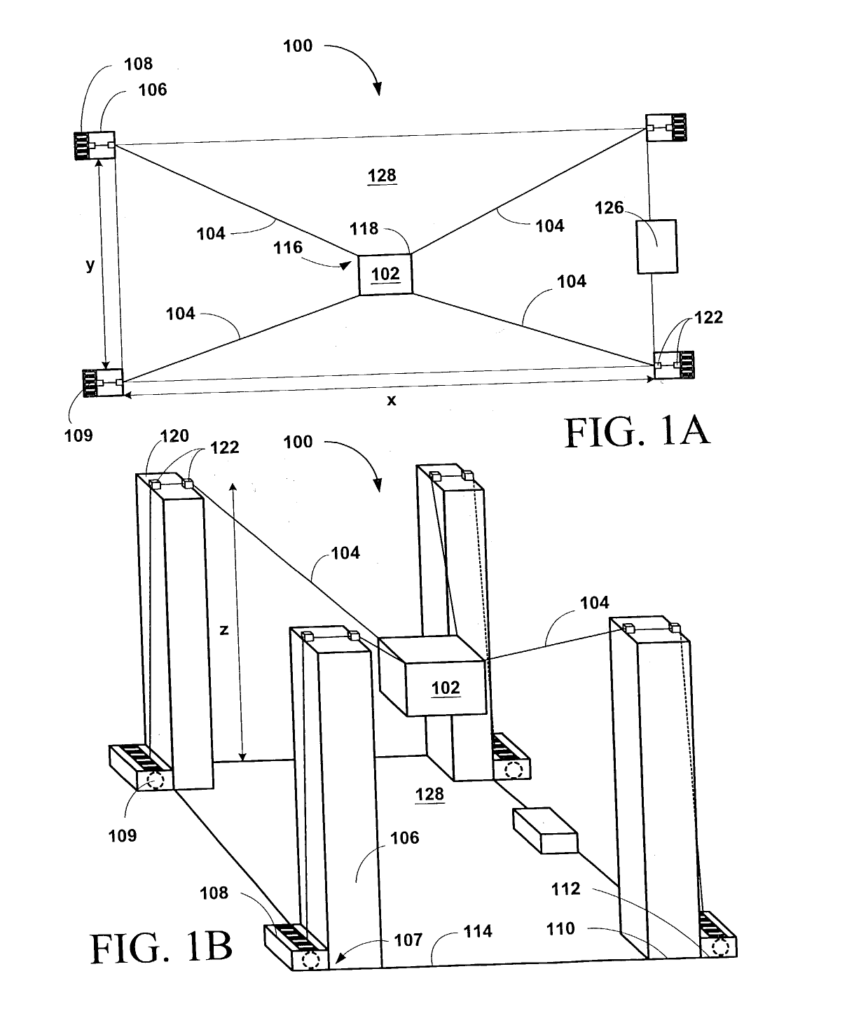

Referring now to FIGS. 1A&B, a preferred embodiment, generally 100, of a platform apparatus of this invention is shown to include an end effector 102, four cables 104, four support towers 106 and four winches 108 located at an outer base 107 of each tower 106 and having a reel 109 upon which the cable(s) 104 associated therewith is wound and unwound, where a bottom 110 of the tower 106 and a bottom 112 of the winches 108 rest on a surface 114. Each cable 104 is attached at its distal end 116 to a vertex 118 of the end effector 102, passes over a top 120 of one of the towers 106 through guides 122 and is attached at its proximal end 124 to one of the winches 108. The winches 108 are controlled by control unit 126, which is in control communication with the winches 108 via wireless transmission or via wires (not shown), with wireless transmission protocols preferred such as ultra sound, IR, RF, laser, or the like. Of course, each winch 108 will include a remote or wired winch controller responsive to the control unit 126. Preferred winch assemblies will be described later.

By controlling a lengths of the cables 104, the end effector 102 can be positioned anywhere within a volume 128 defined by an x dimension shown by a double arrow ended line labeled x in FIG. 1A, the y dimension shown by the double arrow ended line labeled y in FIG. 1A and the z dimension shown by the double arrow ended line labeled z in FIG. 1B. The control unit 126 is designed to control the release and take-up of the cables 104 attached to the vertices 118 of the end effector 102 via the winches 108, simultaneously. If a user desired to position the end effector 102 at any given position within the volume 128, the control unit 126 would issue commands to the winches 108 directing each winch 108 to either decrease or increase the length of its attach cable(s) 104. Thus, it should be apparent to an ordinary artisan that the lengths of the cables 104, which are controlled by the winches 108, control an xyz position of the end effector 102. The winches 108 also adjust the lengths of the cables 104 to compensate for any cable stretch.

Because a weight of the end effector 102 and any load attached thereto is distributed through the cables 104 to the towers 106 and winches 108, each tower 106 and winch 108 bear only a portion of the weight. The portion of weight borne by each tower and winch will depend on the position of the end effector. It is this ability to distribute the weight over a plurality of support structures that contributes to the unique versatility and usefulness of this platforms of this invention and the ability to install the apparatus in an existing building without significant modifications to the building or to install the platform in an open space.

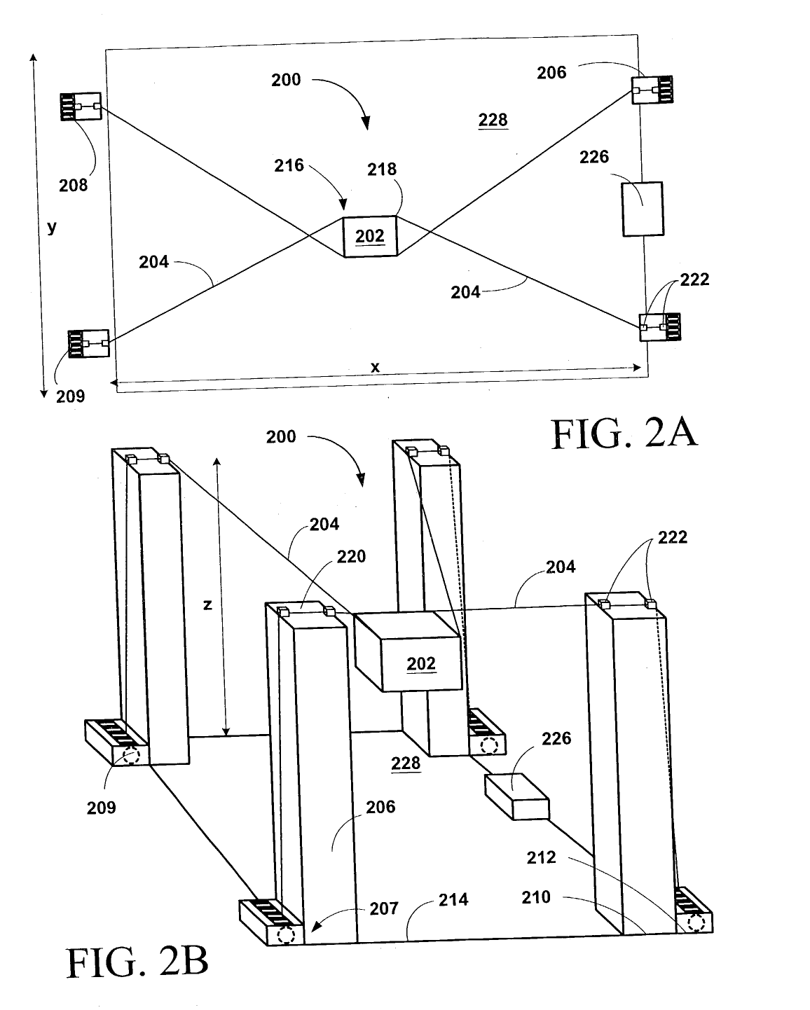

Referring now to FIGS. 2A&B, another preferred embodiment, generally 200, of a platform apparatus of this invention is shown to include an end effector 202, four cables 204, four support towers 206 and four winches 208 located at an outer base 207 of each tower 206, where a bottom 210 of each tower 206 and a bottom 212 of each winch 208 rest on a surface 214. Each cable 204 is attached at its distal end 216 to a vertex 218 of the end effector 202, passes over a top 220 of one of the towers 206 through guides 222 and is attached at its proximal end 224 to one of the winches 208. The guides 222 closed to the end effector 202 can pivot to align with the line of force on each cable 204. In another embodiment, the guides 222 can also be supported on a rotatable table to allow both guides 222 to align with the line of force on the cables 204.

Again, the winches 208 are controlled by a control unit 226 and by controlling a lengths of the cables 204, the end effector 202 can be positioned anywhere within a volume 228. Unlike the volume 128 of FIGS. 1A&B, the volume 228 is larger. The cables 204 of this embodiment assume a crossed format 230, which allows the end effector 202 to cover a larger volume. Comparing the volumes, the volume 228 is defined by the x dimension shown by the double arrow ended line labeled x in FIG. 2A, which is larger than the y dimension in FIG. 1A, the y dimension shown by the double arrow ended line labeled y in FIG. 2A, which is the same as the y dimension shown in FIG. 1A, and the z dimension shown by the double arrow ended line labeled z in FIG. 2B, which is the same as the z dimension shown in FIG. 1B.

Again, the control unit 226 is designed to control the release and take-up of the cables 204 attached to the vertices 218 of the end effector 202 via the winches 208, simultaneously. Thus, if a user desired to position the end effector 202 at any given position within the volume 228, the control unit 226 would issue commands to the winches 208 directing each winch 208 to either decrease or increase the length of its attach cable or cables 204. The length of the cables 204 controls an xyz position of the end effector 202 within the volume 228.

Again, because a weight of the end effector 202 and any load attached thereto is distributed through the cables 204 to the towers 206 and winches 208, each tower 206 and winch 208 bear only a portion of the weight. The portion of weight borne by each tower and winch will depend on the position of the end effector. It is this ability to distribute the weight over a plurality of support structures that contributes to the unique versatility and usefulness of this platforms of this invention and the ability to install the apparatus in an existing building without significant modifications to the building or to install the platform in an open space.

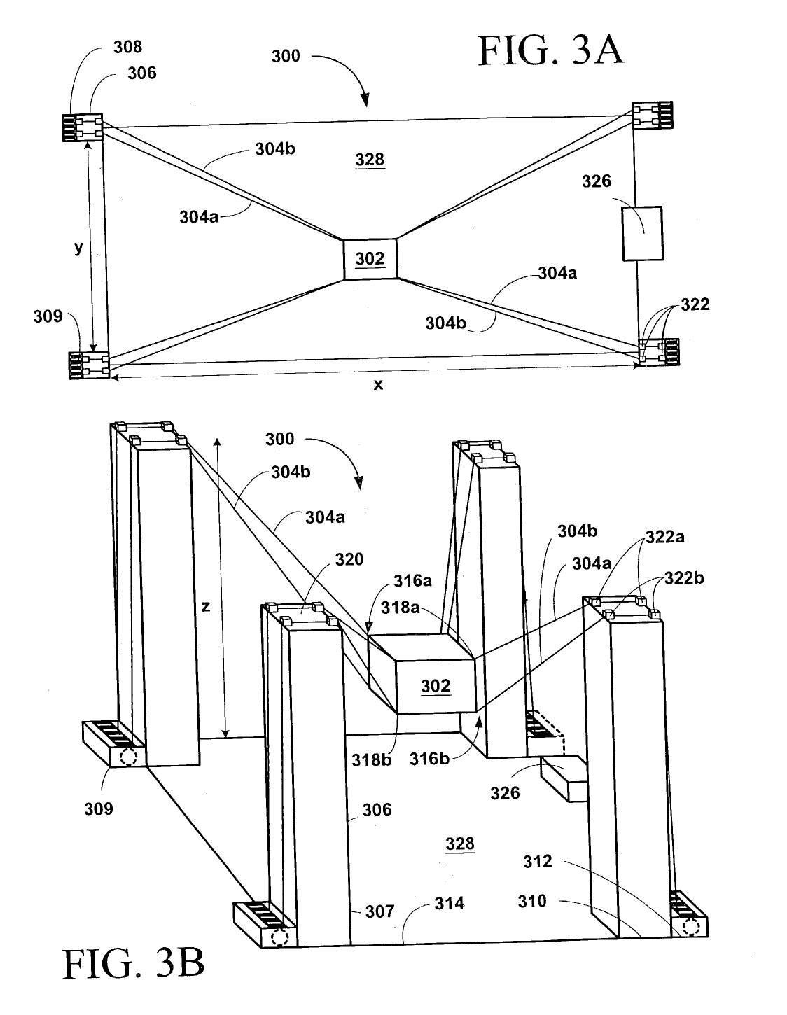

Referring now to FIGS. 3A&B, a preferred embodiment, generally 300, of a platform apparatus of this invention is shown to include an end effector 302, four top cables 304a, four bottom cables 304b, four support towers 306 and four winches 308, where a bottom 310 of the tower 306 and a bottom 312 of the winches 308 rest on a surface 314. Each top cable 304a is attached at its distal end 316a to a top vertex 318a of the end effector 302, passes over a top 320 of one of the towers 306 through guides 322a and is attached at its proximal end to one of the winches 308. Each bottom cable 304b is attached at its distal end 316b to a bottom vertex 318b of the end effector 302, passes over a top 320 of one of the support members 306 through guides 322b and is attached at its proximal end to one of the winches 308. Thus, each winch 308 controls the length and tension on a top cable 304a and a bottom cable 304b. Again, the winches 308 are controlled by control unit 326 via wireless transmission or via wires (not shown), with wireless transmission protocols preferred such as ultra sound, IR, RF, laser, or the like. Of course, each winch 308 will include a remote or wired winch controller responsive to the control unit 326. Preferred winch assemblies will be described later.

Again, the control unit 326 is designed to control the release and take-up of the cables 304a&b attached to the vertices 318a&b of the end effector 302 via the winches 308, simultaneously. Thus, if a user desired to position the end effector 302 at any given position within the volume 328, the control unit 326 would issue commands to the winches 308 directing each winch 308 to either decrease or increase the length of its attach cables 304a&b. The length of the cables 304a&b controls an xyz position of the end effector 302 within the volume 328, which is the same as the volume 128 of FIGS. 1A&B.

Again, because a weight of the end effector 302 and any load attached thereto is distributed through the cables 304 to the towers 306 and winches 308, each tower 306 and winch 308 bear only a portion of the weight. The portion of weight borne by each tower and winch will depend on the position of the end effector. It is this ability to distribute the weight over a plurality of support structures that contributes to the unique versatility and usefulness of this platforms of this invention and the ability to install the apparatus in an existing building without significant modifications to the building or to install the platform in an open space.

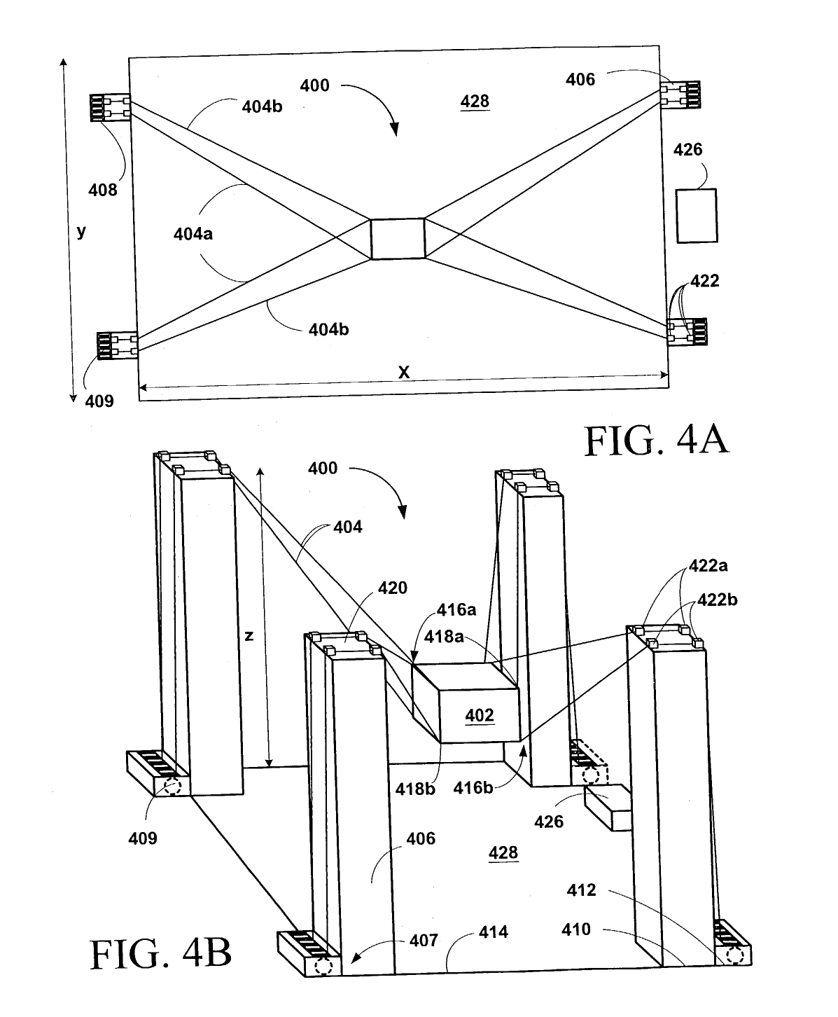

Referring now to FIGS. 4A&B, another preferred embodiment, generally 400, of a platform apparatus of this invention is shown to include an end effector 402, four top cables 404a, four bottom cables 404b, four support towers 406 and four winches 408, where a bottom 410 of the tower 406 and a bottom 412 of the winches 408 rest on a surface 414. Each top cable 404a is attached at its distal end 416a to a top vertex 418a of the end effector 402, passes over a top 420 of one of the support members 406 through guides 422a and is attached at its proximal end to one of the winches 408. Each bottom cable 404b is attached at its distal end 416b to a bottom vertex 418b of the end effector 402, passes over a top 420 of one of the support members 406 through guides 422b and is attached at its proximal end to one of the winches 408. Thus, each winch 408 controls the length of a top cable 404a and a bottom cable 404b. However, unlike the platform of FIGS. 3A&B, this preferred embodiment has the top cables 404a crossed and the bottom cables 404b uncrossed. Again, the winches 408 are controlled by control unit 426 via wireless transmission or via wires (not shown), with wireless transmission protocols preferred such as ultra sound, IR, RF, laser, or the like. Of course, each winch 408 will include a remote or wired winch controller responsive to the control unit 426. Preferred winch assemblies will be described later.

By controlling a length of and tension on the cables 404a&b, the end effector 402 can be positioned anywhere within a volume 428. The volume 428 is the same as the volume 228 of FIGS. 2A&B, which is defined by the x dimension shown by the double arrow ended line labeled x in FIG. 4A, the y dimension shown by the double arrow ended line labeled y in FIG. 2A, and the z dimension shown by the double arrow ended line labeled z in FIG. 2B.

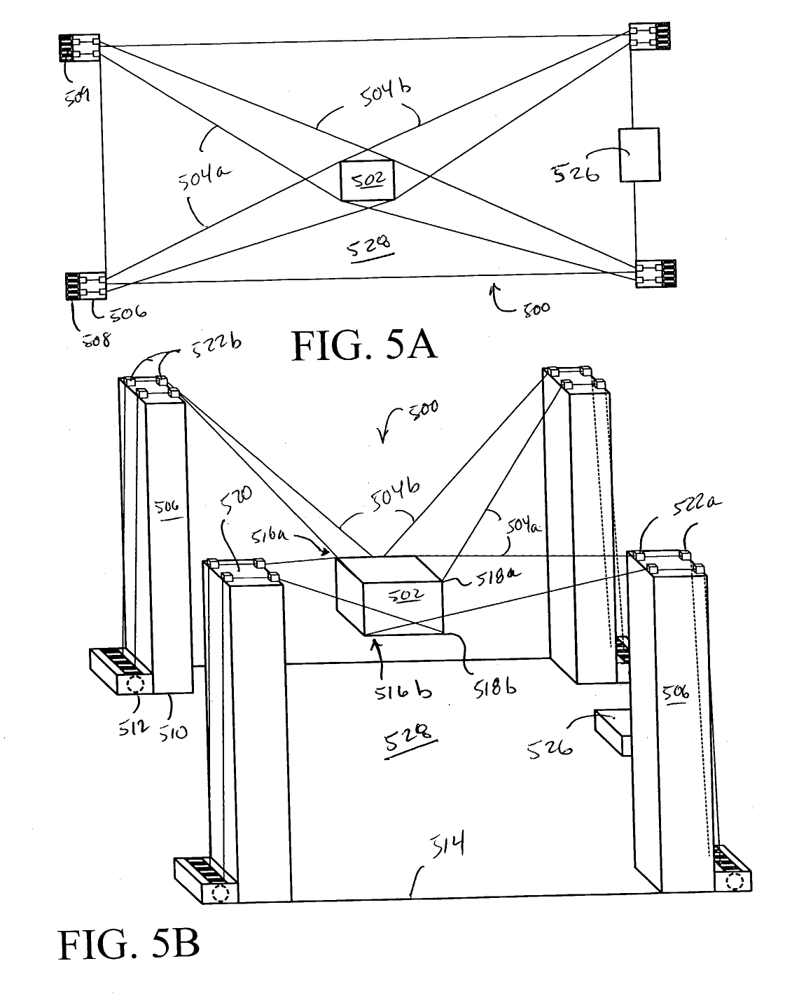

Referring now to FIGS. 5A&B, a preferred embodiment, generally 500, of a platform apparatus of this invention is shown to include an end effector 502, four top cables 504a, four bottom cables 504b, four support towers 506 and four winches 508, where a bottom 510 of the tower 506 and a bottom 512 of the winches 508 rest on a surface 514. Each top cable 504a is attached at its distal end 516a to a top vertex 518a of the end effector 502, passes over a top 520 of one of the towers 506 through guides 522a and is attached at its proximal end to one of the winches 508. Each bottom cable 504b is attached at its distal end 516b to a bottom vertex 518b of the end effector 502, passes over a top 520 of one of the support members 506 through guides 522b and is attached at its proximal end to one of the winches 508. Thus, each winch 508 controls the length of a top cable 504a and a bottom cable 504b. Preferably, these winches have two reels, one for each cable and each reel is separately controlled so that each cable can be take up or let out independently. However, unlike the platform of FIGS. 4A&B, this preferred embodiment has both the top cables 504a and the bottom cables 504b crossed on different sides of the end effector 502. Again, the winches 508 are controlled by control unit 526 via wireless transmission or via wires (not shown), with wireless transmission protocols preferred such as ultra sound, IR, RF, laser, or the like. Of course, each winch 508 will include a remote or wired winch controller responsive to the control unit 526. Preferred winch assemblies will be described later.

By controlling a length of and tension on the cables 504a&b, the end effector 502 can be positioned anywhere within a volume 528.

Again, because a weight of the end effector 502 and any load attached thereto is distributed through the cables 504 to the towers 506 and winches 508, each tower 506 and winch 508 bear only a portion of the weight depending on the position of the end effector 502.

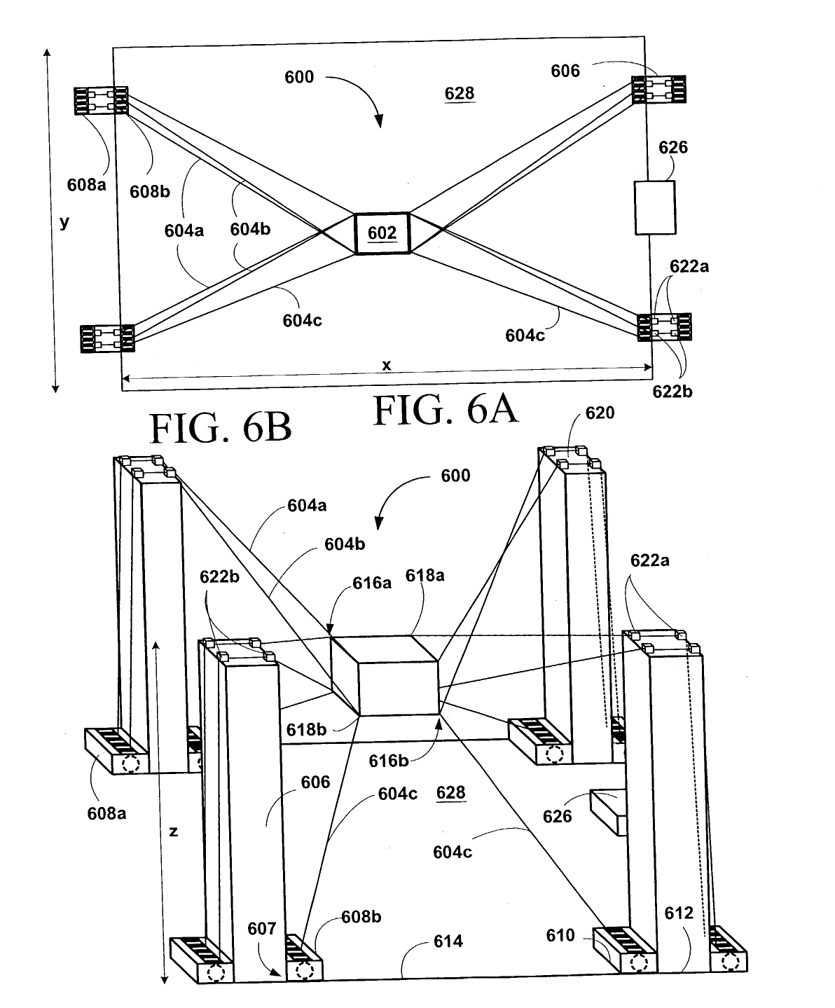

Referring now to FIGS. 6A&B, a preferred embodiment, generally 600, of a platform apparatus of this invention is shown to include an end effector 602, four top cables 604a, four bottom cables 604b, four stability cables 604c, four support towers 606, four outer winches 608a and four inner winches 608b, where a bottom 610 of the tower 606 and a bottom 612 of the winches 608 rest on a surface 614. Each top cable 604a is attached at its distal end 616a to atop vertex 618a of the end effector 602, passes over a top 620 of one of the towers 606 through guides 622a and is attached at its proximal end to one of the winches 608. Each bottom cable 604b is attached at its distal end 616b to a bottom vertex 618b of the end effector 602, passes over a top 620 of one of the towers 606 through guides 622b and is attached at its proximal end to one of the winches 608. Each stability cables 604c is attached at Thus, each winch 608a controls the length and tension on a top cable 604a and a bottom cable 604b. Again, the winches 608a&b are controlled by control unit 626 via wireless transmission or via wires (not shown), with wireless transmission protocols preferred such as ultra sound, IR, RF, laser, or the like. Of course, each winch 608 will include a remote or wired winch controller responsive to the control unit 626.

By controlling a length of and tension on the cables 604a&b, the end effector 602 can be positioned anywhere within a volume 628 similar to the volume 228 of FIGS. 2A&B.

Because a weight of the end effector 602 and any load attached thereto is distributed through the cables 604 to the towers 606 and winches 608, each tower 606 and winch 608 bear a portion of the weight depending on the position of the end effector.

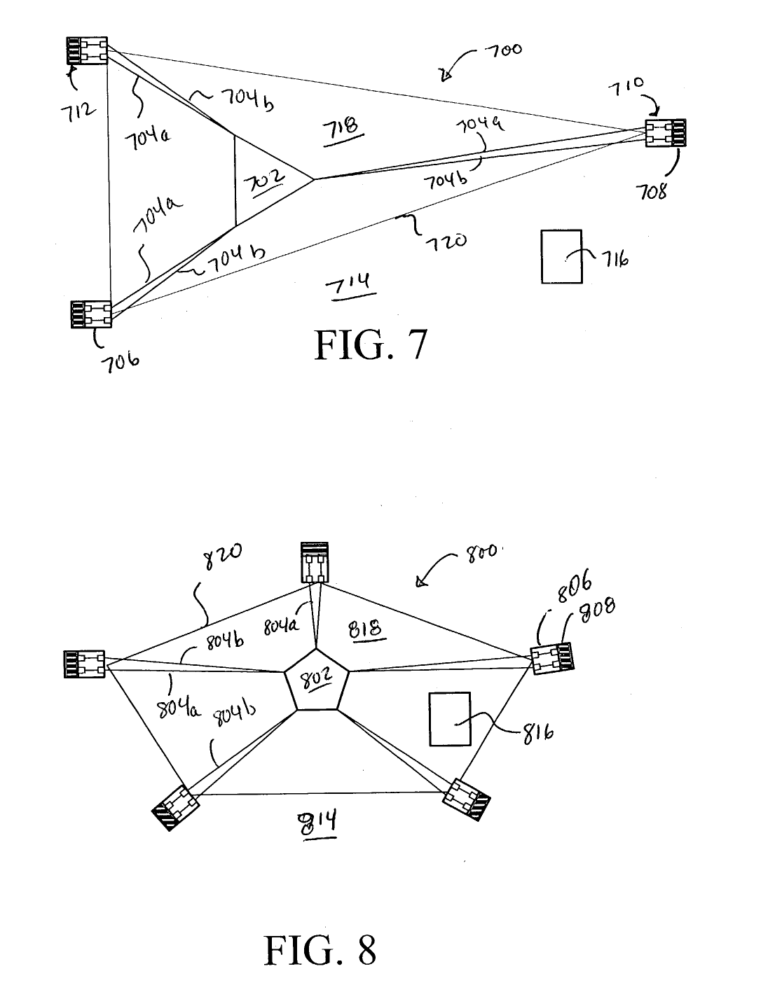

Referring now to FIG. 7, a preferred embodiment, generally 700, of a platform apparatus of this invention is shown to include a triangular end effector 702, three top cables 704a, three bottom cables 704b, three support towers 706 and three winches 708, where a bottom 710 of the tower 706 and a bottom 712 of the winches 708 rest on a surface 714. The cables 704a&b are in a non-crossed configuration. Again, the control unit 716 controls the winches 708 that in turn control the lengths of the cables 704a&b, which in turn control an xyz position of the end effector 702 within a volume 718, shown as a triangle 720 in FIG. 7.

Referring now to FIG. 8, a preferred embodiment, generally 800, of a platform apparatus of this invention is shown to include a pentagonal solid end effector 802, five top cables 804a, five bottom cables 804b, five support towers 806 and five winches 808, where a bottom 810 of the tower 806 and a bottom 812 of the winches 808 rest on a surface 814. The cables 804a&b are in a non-crossed configuration. Again, the control unit 816 controls the winches 808 that in turn control the lengths of the cables 804a&b, which in turn control an xyz position of the end effector 802 within a volume 818, shown as a triangle 820 in FIG. 8.

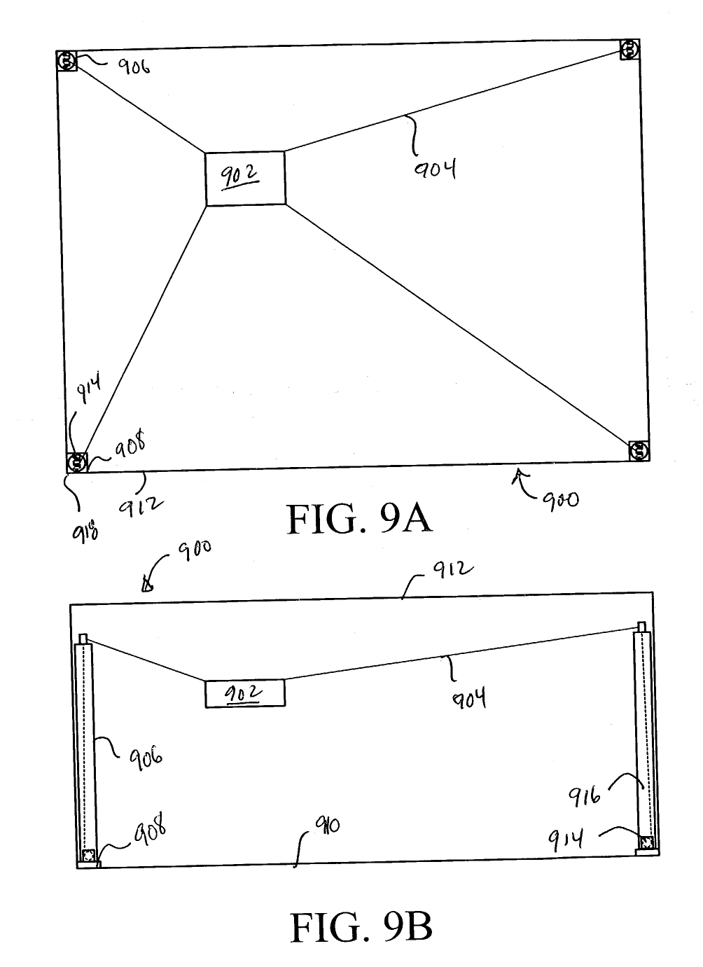

Referring now to FIGS. 9A&B, a preferred embodiment, generally 900, of a platform apparatus of this invention installed in a preexisting building is shown to include an end effector 902, four cables 904, four cylindrical support towers 906, each tower 906 resting on a rotatable foundation 908 anchored to or affixed to a floor 910 of the building 912 and four winches 914 housed within an interior 916 of the towers 906 above the rotatable foundation 908, where the support towers 906 are affixed in corners 918 of the building 912. Providing for the towers 906 with their associated winches to rotation, allows the winch reel(s) 920 to remain perpendicular to the line of force associated with each cable 904. Although only four cables are shown in this invention, the apparatus can have many more cables, with a minimum of six cables necessary for permitting six degrees of rotation. For a six cable configuration, two cables would attach to the end effector from two adjacent towers in a crossing configuration at top vertices of the end effector, while the other four cables would attach to the end effector from the other two towers both in crossing configurations, one each to a top and bottom vertices of the end effector. For improve control of the end effector in a six degrees of freedom format, eight cables are preferred as shown in FIGS. 3-6.

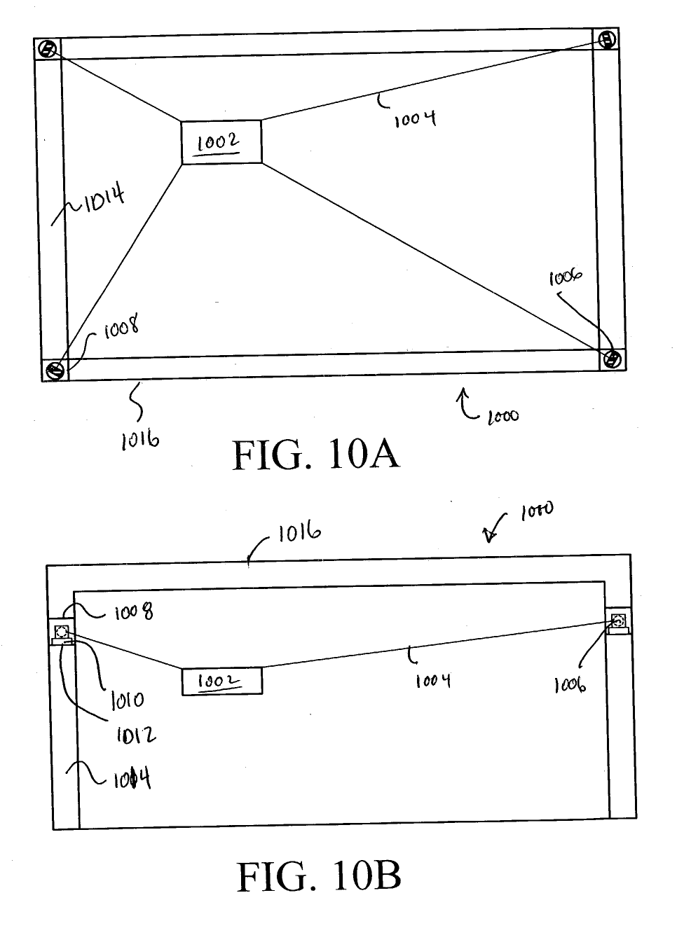

Referring now to FIGS. 10A&B, another preferred embodiment, generally 1000, of a platform apparatus of this invention installed in a preexisting building is shown to include an end effector 1002, four cables 1004,and four winches 1006, each winch 1006 located in a housing 1008 resting on a rotatable foundation 1010 anchored to or affixed to a bottom surface 1012 in a wall 1014 of the building 1016. Providing for the winch rotation, allows the winch reel(s) 1018 to remain perpendicular to the line of force associated with each cable 1004. Again, although only four cables are shown in this invention, the apparatus can have many more cables, with a minimum of six cables necessary for permitting six degrees of rotation. For a six cable configuration, two cables would attach to the end effector from two adjacent towers in a crossing configuration at top vertices of the end effector, while the other four cables would attach to the end effector from the other two towers both in a crossing configuration, one each to a top and bottom vertices of the end effector. For improve control of the end effector in a six degree of freedom format, eight cables are preferred as shown in FIGS. 3-6.

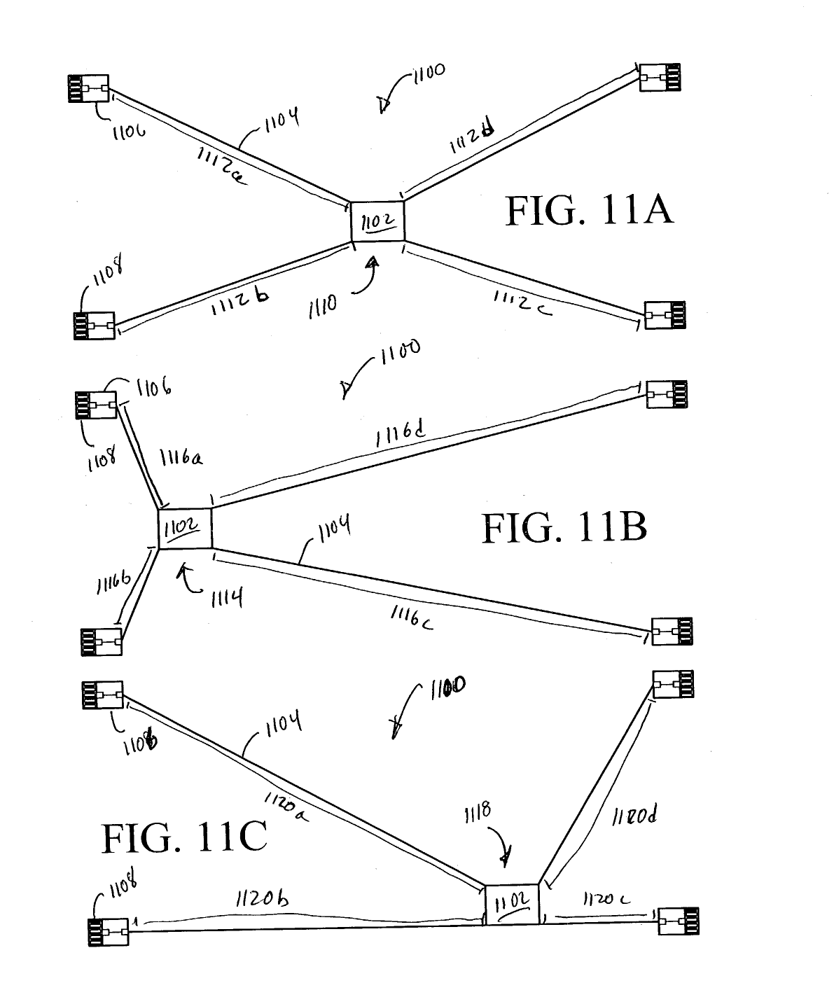

Referring now to FIGS. 11A-C, a four cable apparatus of this invention, generally 1100, is shown to include an end effector 1102, four cables 1104, four support towers 1106 and four winches 1108. Looking at FIG. 11A, the end effector 1102 is in a first xy position 1110 having cable lengths 1112a-d. Looking at FIG. 11B, the end effector 1102 is in a first xy position 1114 having cable lengths 1116a-d. And, looking at FIG. 11C, the end effector 1102 is in a first xy position 1118 having cable lengths 1120a-d. The end effector 1102 changes position by a simply simultaneous change in the length of the cables as is seen from these there figures. Because this is a 2D projection, the z direction is not specified, but it should be clear to an ordinary artisan that xyz positioning is also totally controlled with the length of the cable, provided, of course, that the end effector is within is allowable range of motion. With a minimum of six cable attached to the end effector 1102, in crossing configurations, twisting around the x, y and z directions, independently or collectively, allows the pitch, yaw and roll of the end effector to be changed, by simply and simultaneously changing a length of the cables.

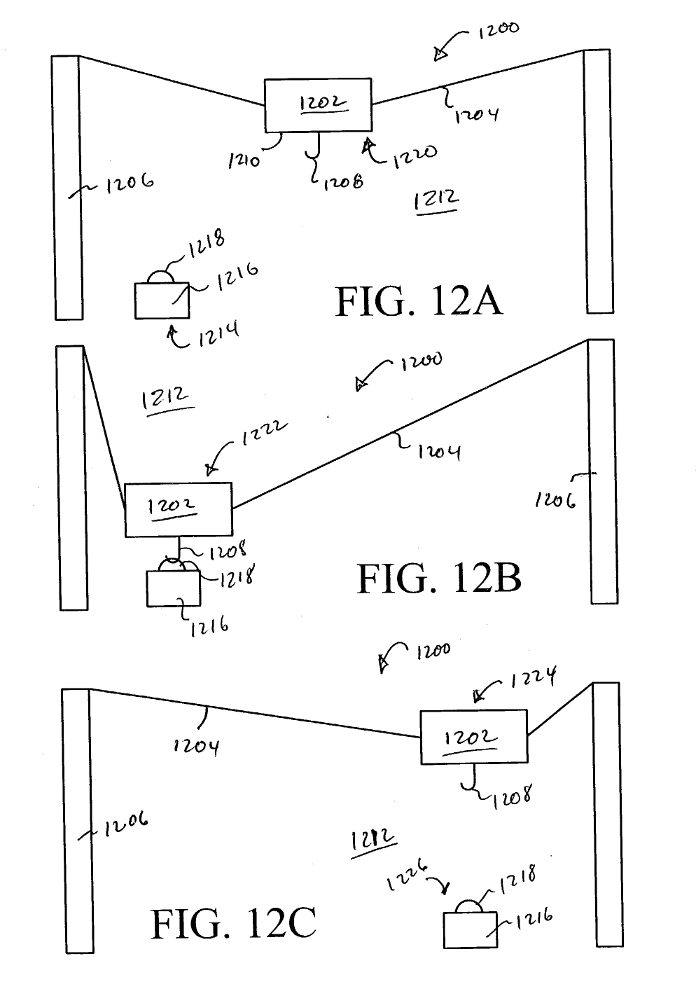

Referring now to FIGS. 12A-C, a preferred method for moving object using an apparatus of this invention is shown, where a platform apparatus, generally 1200, includes an end effector 1202, cables 1204, under winch control (not shown), and four support towers 1206. The end effector 1202 includes a hook 1208, an object attachment member, extending from a bottom surface 1210 thereof. Situated within a volume 1212 accessible to the end effector 1202 at an object start position 1214 is an object 1216 having a loop 1218, an end effector attachment member. Looking at FIG. 12A, the end effector 1202 is located at a end effector start position 1220. Looking at FIG. 12B, the cable lengths of the cables 1204 to the end effector 1202 have changed and the end effector 1202 is moved to an object engaging position 1222, where the hook 1208 engages the loop 1218. Looking at FIG. 12C, the end effector 1202 is in a final position 1224, after having moved the object from its start position 1216 to its final position 1226. It should be recognized by an ordinary artisan that the final object position 1226 could be on a fork lift, a conveyer system, a truck, a train or other transportation device, and, similarly, the object start position 1216 could be on a fork lift, a conveyer system, a truck, a train or other transportation device. Thus, the apparatus of this invention can load and unload materials. Moreover, the final and/or initial object positions 1226 and 1216 can be on moving surfaces such as a conveyor build, train car, truck bed, ship or the like.

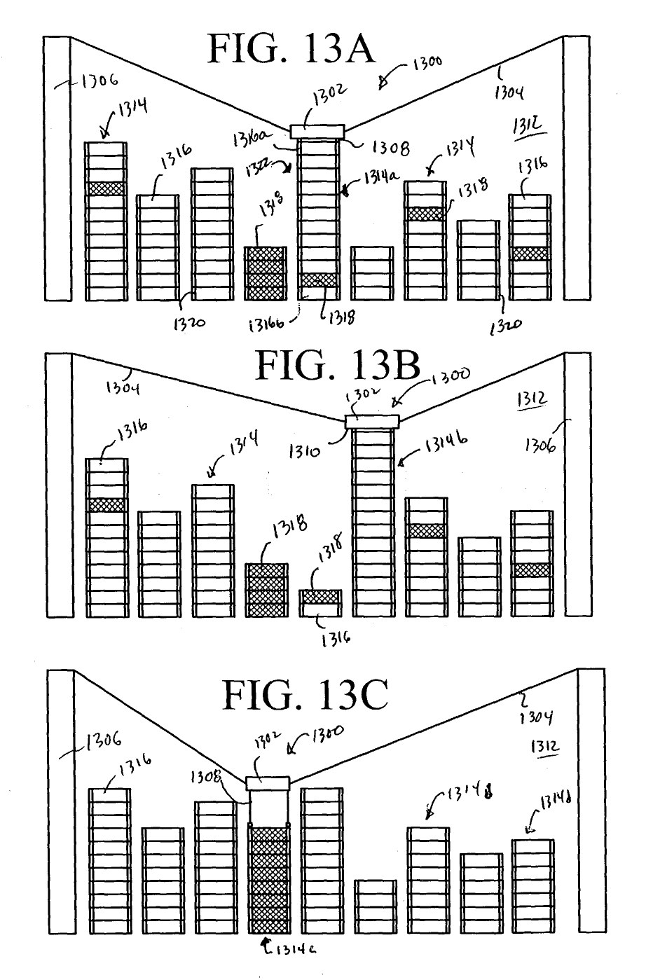

Referring now to FIGS. 13A&B, a method for using a platform apparatus of this invention for inventory control, is shown to include an platform apparatus, generally 1300, of this invention including an end effector 1302, cables 1304, under winch control (not shown), and four support towers 1306. The end effector 1302 includes a extendable object attachment member 1308, located on its bottom surface 1310. Situated within a volume 1312 accessible to the end effector 1302 are stacks 1314 of objects 1316 and 1318.

As seen in the FIGS. 13A&B, the objects 1318 are distributed throughout the stacks 1314. In response to commands issued from a control unit (not shown) to the cable control devices (not shown), the end effector 1302 is moved and the extendable object attachment member 1308 is allowed to engage a top object 1316a of one of the stacks 1314a including an object 1318. Each object 1316 or 1318 includes a mechanically, magnectically, and/or electrically operated lockable attachment member 1320 so that the containers in each stack can be interlocked. Thus, when the end effector 1302 attaches to the stack 1314a, the object attachment member 1308 of the end effector 1302 engages the lockable member 1320 of the object 1316a. By manipulation of the locking mechanism of the lockable members 1320, the lockable member 1320 of the object 1318 of the stack 1314a is unlocked from a lower object 1316b, while all other lockable members 1320 remain locked to their adjacent objects.

The attached objects 1322 are then moved to a stack 1314b as shown in FIG. 13B. This process is continued until, all of the objects 1318 are in a single stack 1314c, while the other stacks 1314d comprise only the objects 1316. Looking at FIG. 13C, the attachment member 1308 is shown in an extended state. The extendability of the attachment member 1308 is necessary to permit the end effector 1302 to attach to and to lift objects that are inaccessible to the bottom surface 1310 of the end effector 1302 because the cables would contract a top of one of the stacks 1314.

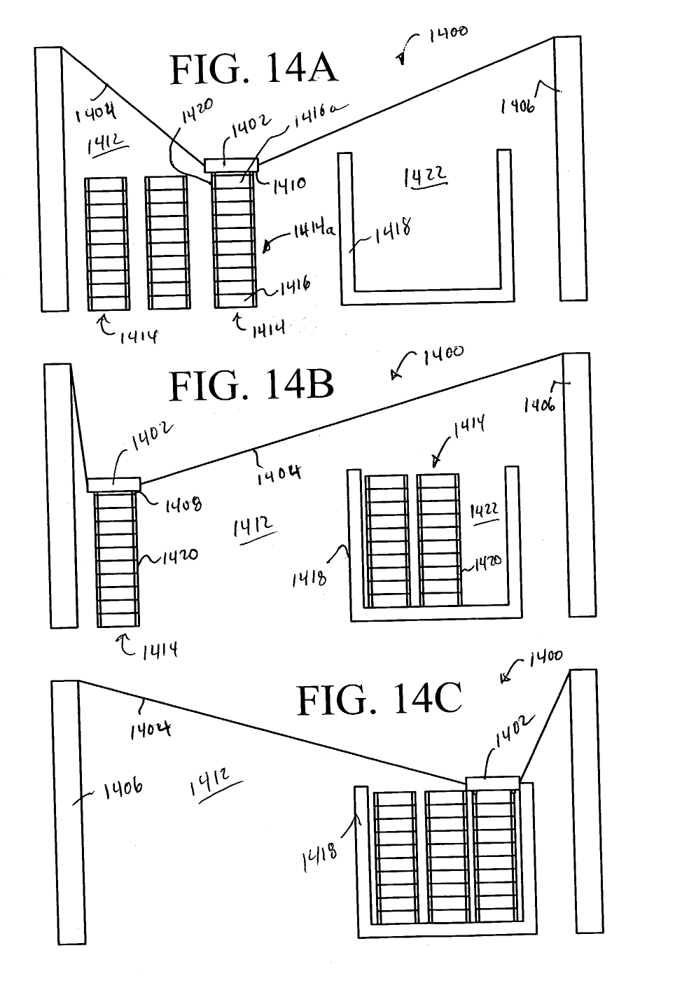

Referring now to FIGS. 14A&B, a method for using a platform apparatus of this invention for top loading a container, is shown to include an platform apparatus, generally 1400, of this invention including an end effector 1402, cables 1404, under winch control (not shown), and four support towers 1406. The end effector 1402 includes an extendable object attachment member 1408, located on its bottom surface 1410. Situated within a volume 1412 accessible to the end effector 1402 are stacks 1414 of objects 1416 to be loaded into a top opening container 1418. Looking at FIG. 14A, the end effector 1402 is positioned over the first stack 1414a and the attachment member 1408 engages an end effector engagement member 1420 of a first object 1416a in the stack 1414a. The object attachment member 1408 can be a threaded pipe that turns into threaded engagement member 1420 to a desired depth into the stack. Alternatively, the engage members 1420 includes remote controlled motors in telemetric communication with a control unit, where the control unit can issue commands to the motors to either lock and/or unlock top and/or bottom adjacent objects. The stacks 1414 are then each moved from the volume 1412 to an interior 1422 of the container 1418, as shown in FIGS. 14B&C. After the container 1418 is loaded, a top cover (not shown) can be replaced and the contents locked. Using this system to load and/or unload such container, will cut down on theft because the contents are loaded from the top making unauthorized unloading more difficult.

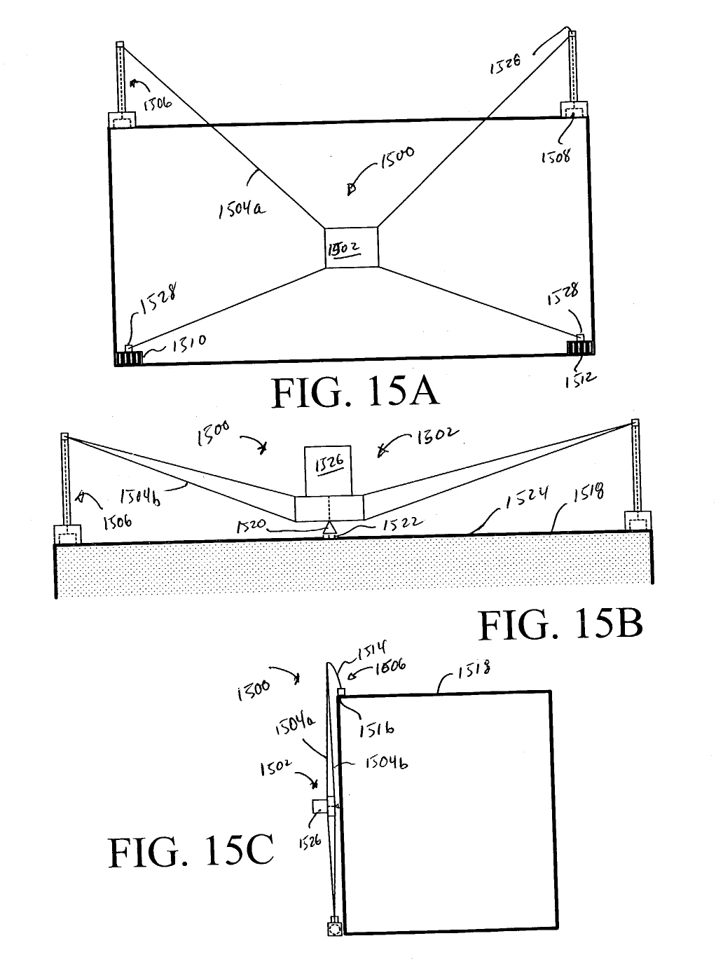

Referring now to FIGS. 15A&B, a method for applying a material to an exterior surface of a building using an apparatus of this invention is shown, to include an apparatus, generally 1500, of this invention including an end effector 1502, four top cables 1504a, four bottom cables 1504b, two support towers 1506, each tower 1506 having a winch 1508 and two housings 1510, each housing 1510 having a winch 1512. Each tower 1506 includes a curved member 1514, adapted to allows control of the end effector 1502 out past an edge 1516 of the building 1518. The end effector 1502 includes a material applicator 1520 applying a material 1522 to the exterior surface 1524 of the building 1518. The end effector 1502 also includes a reservoir 1526 for storing the material being applied. Each tower 1506 and winch 1508 combination includes a guide 1528 as does each housing 1510 and winch 1512 combination. Of course, one of ordinary skill in the art should recognized that the reservoir can be replace by a house leading from a reservoir positioned one the ground or on top of the building. The housings 1510 and their associated winches 1512 are situated on the ground near a bottom 1530 of the building. The housings 1510 and the towers 1506 can be mounted on rotatable tables or foundations so that the winch reels 1532 can orient substantially perpendicular to the vector line of force associated with each cable 1504a&b. The material is applied to the surface as the end effector 1502 controlled by the lengths of the cables 1504a&b moves across the building's surface. For cleaning purposes, the material being applied could be a cleaning material such as water, sand, cleaning solutions or the like. The material can be paint, window tinting, or the like. For removing material from the surface, the applicator would be replace with a device designed to remove material from the surface such as a scraper or the like.

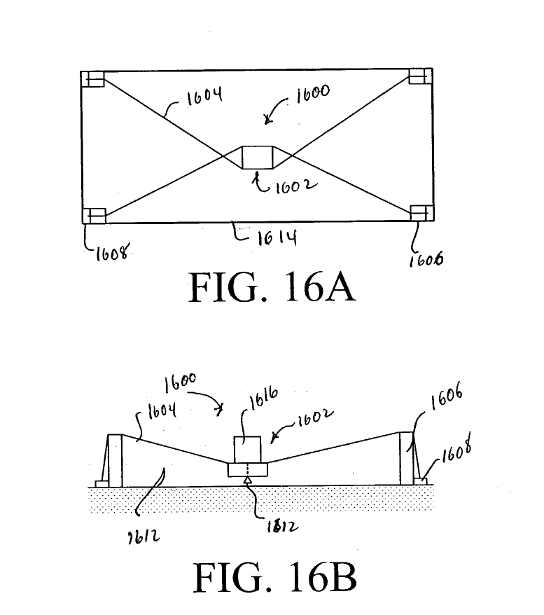

Referring now to FIGS. 16A&B, a method for applying a material to a flat horizontal surface using an apparatus of this invention is shown, to include an apparatus, generally 1600, of this invention including an end effector 1602, four cables 1604, four support towers 1606, each tower 1606 having a winch 1608. The end effector 1602 includes a material applicator 1610 applying a material 1612 to the surface 1614. The end effector 1602 also includes a reservoir 1616 for storing the material 1612 being applied. Of course, one of ordinary skill in the art should recognized that the reservoir can be replace by a house leading from a remote reservoir. The towers 1606 and winch 1608 combinations can be mounted on rotatable tables or foundations so that the winch reels 1618 can orient substantially perpendicular to the vector line of force associated with each cable 1604. The material is applied to the surface as the end effector 1602 controlled by the lengths of the cables 1604 moves across the surface 1614. For cleaning purposes, the material being applied could be a cleaning material such as water, sand, cleaning solutions or the like. The material can be paint, window tinting, or the like. For removing material from the surface, the applicator would be replace with a device designed to remove material from the surface such as a scraper or the like. For applying material to, cleaning or removing material from curved surfaces, an apparatus of this invention with three towers is preferred to expedient easy relocation of some or all of the towers as the job progressed. Relocating the towers is necessary because the curvature of the surface generally would not permit one tower configuration to allow the end effector to get to every point on the surface. The number of times the towers would have to be relocated will depend on the height of the towers and the curvature of the surface. The higher the towers, the less relocation. The more curved the surface, the greater the relocation. If one were painting an exterior of a spherical surface, then one would position on tower at the north pole of the sphere and the other two tower on the a line parallel to the mid point of the sphere (the equator) depending on the radius of curvature and apply paint to a sector at a time, where the size of the sector would be controlled by the distance between the two towers on the line parallel to the equator. Of course, that line could be the equator in situations where the curvature so allows. If the curvature does not permit the other two towers to be located on the equator, then to complete painting a four tower apparatus would be used with two towers located the line marking the end of the painted part of the sphere and the other two on another line parallel to the equator, where pairs of towers would be located on lines of latitude going from pole to pole. Thus, a spherical surface could be painted much in the same manner that a sphere is generated in 3D modeling using polygonal surfaces.

All references cited herein are incorporated herein by reference. While this invention has been described fully and completely, it should be understood that, within the scope of the appended claims, the invention may be practiced otherwise than as specifically described. Although the invention has been disclosed with reference to its preferred embodiments, from reading this description those of skill in the art may appreciate changes and modification that may be made which do not depart from the scope and spirit of the invention as described above and claimed hereafter.

We claim:

1. An apparatus comprising an end effector, a plurality of tension member, a plurality of controller, and a digital processing unit in command communication with the controllers, where each tension member is connected at its distal end to a vertex of the end effector and at its proximal end to one of the controllers, where the controllers control a length and tension of each tension member, thereby controlling the position of the end effector within a volume inscribed by locations of the controllers and where the digital processing unit controls the controllers.

2. An apparatus comprising an end effector, a plurality of tension member, a plurality of support member, each support member includes a controller, and a digital processing unit in command communication with the controllers, where each control is located on a top of its corresponding support member, where each tension member is connected at its distal end to a vertex of the end effector and at its proximal end to one of the controllers, where the controllers control a length and tension of each tension member, thereby controlling the position of the end effector within a volume inscribed by locations of the controllers and where the digital processing unit controls the controllers.

3. An apparatus comprising an end effector, a plurality of tension member, a plurality of support member, each support member includes a controller, and a digital processing unit in command communication with the controllers, where each control is located on a bottom of its corresponding support member, where each tension member is connected at its distal end to a vertex of the end effector, passes over a top of one of the support members and is connected at its proximal end to the corresponding controller, where the controllers control a length and tension of each tension member, thereby controlling the position of the end effector within a volume inscribed by locations of the controllers and where the digital processing unit controls the controllers.
